(19) United States
(12) Patent Application Publication
(10) Pub. No.: US 2025/0215625 A1
(43) Pub. Date: Jul. 3, 2025

(54) CONTINUOUS MANUFACTURING OF CARBON FIBER STRUCTURE

(71) Applicant: WILDSTAR, LLC, Saratoga, CA (US)

(72) Inventor: Gregory Thane WYLER, Stuart, FL (US)

(73) Assignee: WILDSTAR, LLC, Saratoga, CA (US)

(21) Appl. No.: 18/977,263

(22) Filed: Dec. 11, 2024

Related U.S. Application Data
(60) Provisional application No. 63/616,663, filed on Dec. 31, 2023.

(51) Int. Cl. D04H 3/002; D01F 9/12; D04H 3/073; D04H 3/08

(52) U.S. Cl. CPC D04H 3/002; D01F 9/12; D04H 3/073; D04H 3/08; D10B 2505/02

(57) ABSTRACT

The disclosed technology is generally directed to a method for manufacturing a carbon fiber structure. In one example of the technology, the method may include mounting inner mold segments on a rod. The rod may correspond to one of: a continuous threaded rod and a cogged center rod. A first motor may spin the rod to linearly move the inner mold segments on the rod. While the inner mold segments are moving linearly, a second motor may spin a set of carbon fiber tows mounted on a mandrel around the inner mold segments to wind a set of carbon fiber threads of the set of carbon fiber tows around the inner mold segments. Further, a set of outer mold segments may compress the wound carbon fiber threads around the inner mold segments by applying heat and pressure to manufacture the carbon fiber structure.

### CROSS REFERENCE TO RELATED APPLICATIONS

This application claims the benefit of U.S. Provisional Application Ser. No. 63/616,663, filed on Dec. 21, 2023, the disclosure of which is incorporated herein by reference.

### TECHNICAL FIELD

This disclosure is directed to manufacturing of carbon fiber structures, and more particularly, to a method and design for continuous manufacturing of carbon fiber structure of multiple shapes and thicknesses.

### BACKGROUND

Fiber materials find widespread use across diverse industries, including commercial aviation, recreation, industrial applications, and transportation. Commonly used fiber materials encompass a range of types, such as carbon fiber, cellulosic fiber, glass fiber, metal fiber, ceramic fiber, and aramid fiber. Carbon fibers, often derived from carbon-rich polymers like polyacrylonitrile (PAN), are extensively utilized. However, the existing methods for producing carbon fiber-reinforced composites may require either high-temperature annealing processes or the use of expensive raw materials. The limitations of these approaches hinder the efficient manufacturing of lightweight structures with diverse applications.

Conventional techniques for manufacturing infinite-length carbon fiber structures involve usage of pultrusion method, where the material is pulled through a die on an advancing mandrel. However, the pulling force applied restricts the use of thinner fibers, limiting the structural thickness achievable to a minimum of 1 mm, which remains relatively thick for certain applications.

Various applications may require a range of continuous carbon fiber structures with diverse shapes beyond conventional circular or square tubes. Current manufacturing processes face challenges in producing structures with intermittent variations that are important for specialized applications. Moreover, there is an increasing demand for ultra-lightweight structures that can be produced at high volumes, facilitating innovative storage and automatic deployment possibilities.

Therefore, in light of the foregoing, there is a need for a technical solution to overcome the challenges associated with conventional manufacturing of carbon fiber structures.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, an embodiment of the present disclosure may provide a method for manufacturing a carbon fiber structure. Implementations of the described techniques may include hardware, or a non-transitory, a computer readable medium, etc. Other embodiments of this aspect include corresponding computer systems, apparatus, and computer programs recorded on one or more computer storage devices, each configured to perform the actions of the methods. The system may include one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations may include one or more of the following features.

In accordance with the method a set of inner mold segments may be mounted on a rod. The rod may correspond to one of: a continuous threaded rod and a cogged center rod. A first motor may spin the rod to linearly move the set of inner mold segments on the rod. While the set of inner mold segments are moving linearly, a second motor may spin a set of carbon fiber tows mounted on a mandrel around the set of inner mold segments to wind a set of carbon fiber threads of the set of carbon fiber tows around the set of inner mold segments. Further, a set of outer mold segments may compress the wound carbon fiber threads around the set of inner mold segments by applying heat and pressure to manufacture the carbon fiber structure.

In an embodiment of the present disclosure, each of the set of inner mold segments is a collapsible mold segment. The set of inner mold segments comprises a first inner mold segment and a second inner mold segment. The second inner mold segment is mounted on the rod after the first inner mold segment moves linearly on the rod, thereby manufacturing the carbon fiber structure of a desired length. In some implementations, the first inner mold segment comprises an upper segment portion that is mounted on the rod from top and a lower segment portion that is mounted on the rod from bottom such that the upper and lower portions of the first inner mold segment move linearly when the rod spins.

In an embodiment of the present disclosure, the first inner mold segment has a different shape than the second inner mold segment such that the carbon fiber structure manufactured may be of different shapes and sizes as per the requirements of specific applications.

Further, in accordance with the method after the compressing of the wound carbon fiber threads, the set of inner mold segments may collapse to release the set of inner mold segments from the rod. Additionally, the manufactured carbon fiber structure may be released by cutting the manufactured carbon fiber structure. In some implementations, the manufactured carbon fiber structure is cut by a knife or a laser technique.

The continuous carbon fiber structure thus manufactured may be as thin and delicate as may be desired because at no point is there a pulling stress. The shapes of the resultant tubes of the carbon fiber structure and the addition of stress doublers of carbon fiber structure may allow for high-speed manufacturing of large structures with various designs. The manufacturing process may be continuous and fully automated allowing for lower costs at high volume. The carbon fiber structure may be of many shapes, creating a single stronger and lighter structure instead of multiple structures glued or attached together.

In another aspect, an embodiment of the present disclosure may provide a system for manufacturing a carbon fiber structure. The system comprises first and second motors and a mandrel. The second motor may be configured to spin the mandrel. The system further includes a rod coupled to the first motor. The first motor may be configured to spin the rod. A set of inner mold segments are mounted on the rod such that the set of inner mold segments move linearly on the rod when the first motor spins the rod. Further, the system comprises a set of carbon fiber tows mounted on the mandrel around the set of inner mold segments and comprising a set of carbon fiber threads. While the set of inner mold segments are moving linearly, the set of carbon fiber threads of the set of carbon fiber tows are wound around the set of inner mold segments when the second motor spins the mandrel. A set of outer mold segments may be configured to compress the wound carbon fiber threads around the set of inner mold segments by applying heat and pressure to manufacture the carbon fiber structure.

Further aspects, features, applications and advantages of the disclosed technology, as well as the structure and operation of various examples, are described in detail below with reference to the accompanying drawings. It is noted that the disclosed technology is not limited to the specific examples described herein. Such examples are presented herein for illustrative purposes only. Additional examples will be apparent to persons skilled in the relevant art(s) based on the teachings contained herein.

### BRIEF DESCRIPTION OF THE SEVERAL VIEWS OF THE DRAWINGS

For a better understanding of the present disclosure, non-limiting and non-exhaustive examples of the present disclosure are described with reference to the following drawings, in which:

FIG. 1 is a simplified diagram illustrating a system for manufacturing of carbon fiber structure in which aspects of the technology may be employed;

FIG. 2 is another simplified diagram illustrating the system for manufacturing of the carbon fiber structure in which aspects of the technology may be employed;

FIGS. 3A-3D, collectively, represent a simplified diagram illustrating a compression technique for manufacturing of continuous carbon fiber structure in which aspects of technology may be employed; and

FIGS. 4A and 4B represent simplified diagrams illustrating various views of an exemplary collapsible mold segments in which aspects of the technology may be employed;

FIGS. 5A-5C, collectively, represent a simplified diagram illustrating a process of manufacturing the double omega shaped structure using the collapsible mold segments of FIGS. 4A and 4B in which aspects of the technology may be employed; and

FIG. 6 is a flowchart that illustrates a method for manufacturing the carbon fiber structure according to aspects of the disclosed technology.

In the drawings, similar reference numerals refer to similar parts throughout the drawings unless otherwise specified. These drawings are not necessarily drawn to scale.

### DETAILED DESCRIPTION

Technologies are provided for manufacturing a carbon fiber structure. Technologies are also provided for continuous manufacturing of the carbon fiber structure. The specification and accompanying drawings disclose one or more exemplary embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

It is noted that any section/subsection headings provided herein are not intended to be limiting. Any embodiments described throughout this specification, and disclosed in any section/subsection may be combined with any other embodiments described in the same section/subsection and/or a different section/subsection in any manner.

Implementations of the techniques described herein may include hardware, a method or process, or a non-transitory computer readable medium, etc. Other embodiments of this aspect include corresponding computer systems, apparatus, and computer programs recorded on one or more computer storage devices, each configured to perform the actions of the methods. The system may include one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations may include one or more of the following features. Prior to describing exemplary embodiments that incorporate the features of the present disclosure, a discussion of carbon fiber structures that are appliable to the exemplary embodiments will be provided.

### Carbon Fiber Structure

Carbon fibers may have a high specific strength and specific modulus and are strong and light materials for use in the fields of space craft, automobiles, and other industries. The mechanical and strength-to-weight properties of carbon fibers have led to an important class of high-performance fiber composites. The high-performance fiber composites are particularly useful for the production of aircraft and automobile body parts for which both strength and light weight are important. Such composites enable manufacturers to produce relatively light weight structures without sacrificing strength. Consequently, much research has been directed to producing carbon fiber materials with high performance properties and physical features that make the composites more valuable in commercial products and processes. In such fields, there is a need for inexpensive materials having a high strength and high modulus. Known carbon fibers include polyacrylonitrile (PAN) based carbon fibers obtained by using PAN as the starting material and pitch-based carbon fibers obtained by using pitch as the starting material, but currently, the PAN based carbon fibers are primarily used as high-performance carbon fibers having a high strength and high modulus.

### Mold Segments

Mold segments may refer to the individual components or sections of a mold used in the manufacturing or casting process. The mold segments may be designed and arranged in a way that, when assembled, they form a complete mold cavity that defines the shape of the final product to be manufactured. Mold segments are integral to various manufacturing processes, including those in the compressing molding, plastic injection molding, metal casting, and glassblowing industries.

### Collapsible Mold Segment (CMS)

Collapsible mold segment, also known as collapsible core or collapsible mold, are a specialized type of mold component used in some molding processes such as compression molding or injection molding processes. The CMSs may be designed to create intricate and complex internal features within a molded part, particularly those with undercuts or negative draft angles. The collapsible nature of these molds allows for easier removal of the finished product without causing damage to the molded part.

### Carbon Fiber tow

Carbon fiber, and more specifically, carbon fiber tow may be used in a variety of industries. Carbon fiber tow may be provided in spools having strands of carbon fiber. Carbon fibers are typically produced as tows including several thousands of carbon fibers. The carbon fiber tow may be used by itself or woven into a fabric. The tow is combined with epoxy or other polymer and wound or molded into shape to form various composite materials. Carbon fiber reinforced composite materials are used in many applications where light weight and high strength are desirable or needed.

### Technical Problem with Conventional Manufacturing of Carbon Fiber Structures

Conventional techniques for manufacturing infinite-length carbon fiber structures involve usage of pultrusion method, where the material is pulled through a die on an advancing mandrel. However, the pulling force applied restricts the use of thinner fibers, limiting the structural thickness achievable to a minimum of 1 mm, which remains relatively thick for some applications.

Various applications may require a range of continuous carbon fiber structures with diverse shapes beyond conventional circular or square tubes. Current manufacturing processes face challenges in producing structures with intermittent variations that may be important for specialized applications. Moreover, there is an increasing demand for ultra-lightweight structures that can be produced at high volumes, facilitating innovative storage and automatic deployment possibilities. The ultra-lightweight carbon fiber structure may enable new levels of storage and automatic deployment.

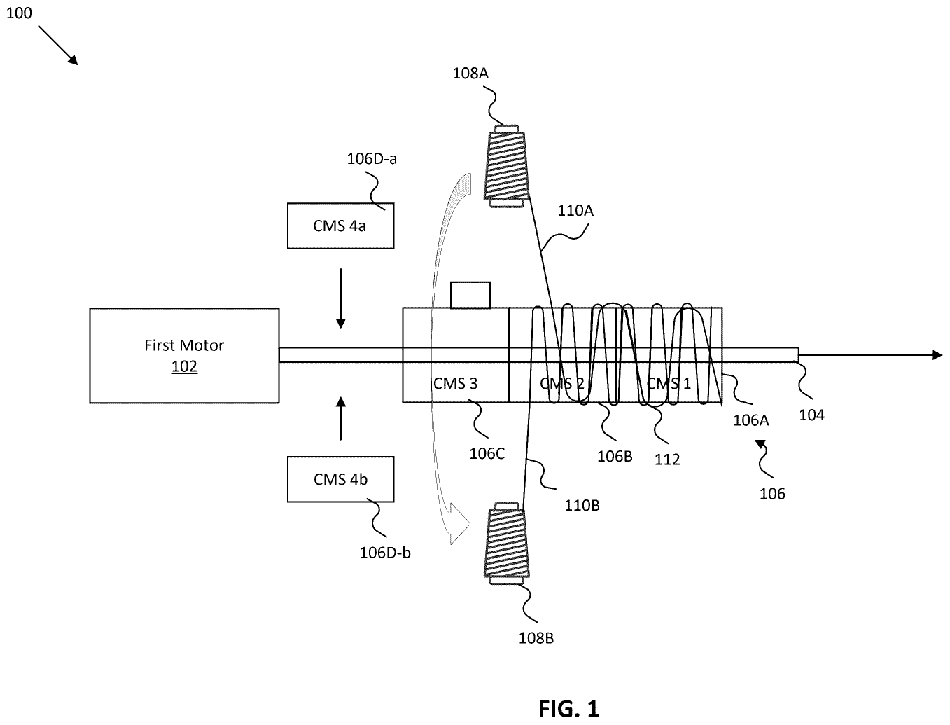

Having given this description of a system for manufacturing a carbon fiber structure that can be applied within the context of the present disclosure, technologies will now be described with reference to FIGS. 1-5 for manufacturing of carbon fiber structures.

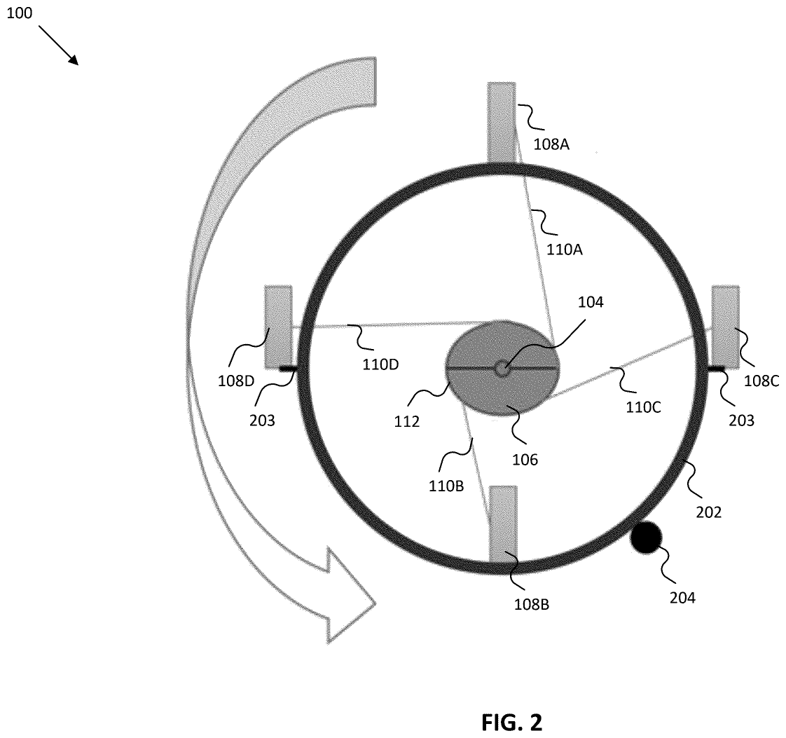

FIG. 1 is a simplified diagram illustrating a system 100 for manufacturing a carbon fiber structure in which aspects of the technology may be employed. FIG. 2 is another simplified diagram illustrating the system 100 for manufacturing the carbon fiber structure in which aspects of the technology may be employed. Referring now to FIG. 1, the system 100 includes a first motor 102, a rod 104, multiple inner mold segments 106, and multiple carbon fiber tows 108. The first motor 102 may be an electric motor that converts electrical energy into mechanical energy. The electric motors operate through the interaction between the motor's magnetic field and electric current in a wire winding to generate force in the form of torque applied on the motor's shaft. Electric motors can be powered by direct current (DC) sources, such as from batteries or rectifiers, or by alternating current (AC) sources, such as a power grid, inverters or electrical generators.

The rod 104 may be coupled to the first motor 102, i.e., the rod 102 is coupled to the motor's shaft. The first motor 102 may be configured to spin the rod 104. The rod 104 corresponds to one of: a continuous threaded rod and a center cogged rod. In one embodiment, the continuous threaded rod, also known simply as a threaded rod or all-thread, can be a long, straight rod with continuous external threads along its entire length. The threads are typically of a uniform size and pitch and run along the entire length (or substantially the entire length) of the rod, allowing nuts or other threaded components to be easily affixed at any point.

The inner mold segments 106 may be mounted on the rod 104. The inner mold segments 106 may move linearly on the rod 104 when the first motor 102 spins the rod 104. Referring now to FIG. 2, in some embodiments, the system 100 may further include a mandrel 202 having guides 203, and a second motor 204. The second motor 204 may be configured to spin the mandrel 202. Referring now to FIGS. 1 and 2, the carbon fiber tows 108 may be mounted on the mandrel 202 around the inner mold segments 106. The carbon fiber tows 108 include carbon fiber threads 110. In some embodiments, the carbon fiber threads 110 may be ultra-thin strands of carbon fibers that are woven or spun together to form a lightweight, high-strength material. Carbon fibers have a high strength-to-weight ratio, stiffness, and resistance to various environmental factors. These threads may be used in applications related to a wide range of industries, including aerospace, automotive, sports equipment, and industrial manufacturing.

While the inner mold segments 106 are moving linearly on the rod 104, the carbon fiber threads 110 of the carbon fiber tows 108 may be wound around the inner mold segments 106 when the second motor 204 spins the mandrel 202. In one embodiment, the carbon fiber tows 108 may include first through fourth carbon fiber tows 108A-108D mounted on the mandrel 202 such that when the mandrel 202 spins first through fourth carbon fiber threads 110A-110D of the first through fourth carbon fiber tows 108A-108D are wound around the inner mold segments 106. In an exemplary embodiment, the first through fourth carbon fiber tows 108A-108D mounted on the mandrel 202 at 45-degree angles. The carbon fiber tows 108 may be placed on the guides 203 of the mandrel 202. The carbon fiber tow 108 may orbit the inner mold segments 106 and spin around the inner mold segments 106. The carbon fiber threads 110 are wound around the inner mold segments 106 forming a shape that may change while maintaining a continuous structure and the shape thus formed is defined by the inner mold segments 106. It may be apparent to a person skilled in the art that although in the current embodiment, the carbon fiber tows 108 include four carbon fiber tows, in various other embodiment, the carbon fiber tows 108 may include any suitable number of carbon fiber tows, without deviating from the scope of the present disclosure.

In another aspect of the present disclosure, the carbon fiber tows 108 may be mounted at fixed locations on the mandrel 202 to enable one of: straight lay downs of fiber and spread tow lay downs. In yet another aspect of the present disclosure, the carbon fiber tows 108 may be mounted on particular sides of the mandrel 202 to enable different patterns of continuous carbon fiber structure along the sides that may also lay sheets on different sections of continuous carbon fiber structure according to the requirements.

In some embodiments, the inner mold segments 106 may include multiple segments such as the first through fourth inner mold segments 106A-106D. In a non-limiting embodiment of the present disclosure, each inner mold segment may be a collapsible mold segment (CMS). Hereinafter the inner mold segments 106 may also be referred to as “CMSs 106”. In an exemplary embodiment of the present disclosure, the first CMS 106A is mounted on the rod 104 and the first motor 102 spins the rod 104 to linearly move the first CMS 106A forward. The second CMS 106B is mounted on the rod 104 after the first CMS 106A moves linearly on the rod 104. Similarly, the third CMS 106C is mounted on the rod 104 when the first and second CMSs 106A and 106B linearly move forward, thereby allowing the system 100 to continuously wind the carbon fiber threads 110 around the CMSs 106.

In some embodiments, each CMS may have a different shape to manufacture a carbon fiber structure having various shapes for specific applications. In one non-limiting example, the third CMS 106C includes a unique bump as shown in the FIG. 1. Additionally, each CMS 106 may include an upper segment portion that is mounted on the rod 104 from top and a lower segment portion that is mounted on the rod 104 from bottom such that the upper and lower portions of the CMS 106 move linearly when the rod 104 spins. In one non-limiting example, the fourth CMS 106D includes an upper segment portion 106D-a (CMS 4a) that is mounted on the rod 104 from top and a lower segment portion 106D-b (CMS 4b) that is mounted on the rod 104 from bottom such that the upper and lower portions 106D-a and 106D-b of the fourth CMS 106D move linearly when the rod 104 spins.

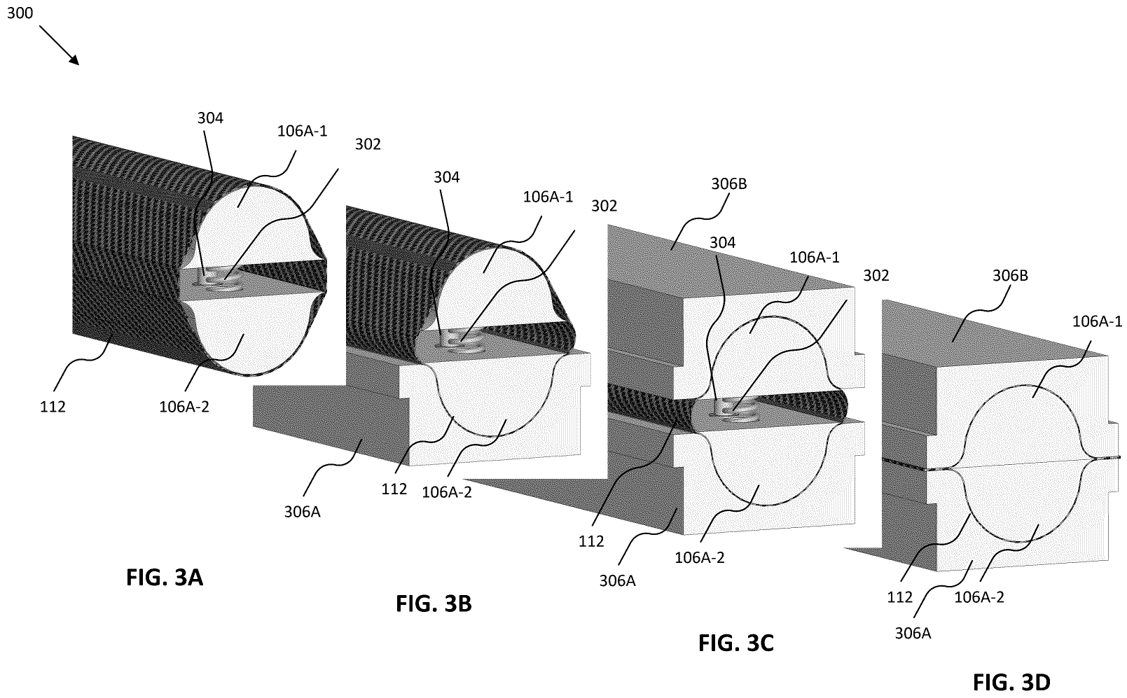

Further, as the CMSs 106 are moving linearly on the rod 104, the outer mold segments (shown later in FIG. 3) are configured to compress different segments of wound carbon fiber threads 112 around the set of inner mold segments by applying heat and pressure to manufacture the carbon fiber structure. As new CMSs 106 are mounted on the rod 104 when the previous CMSs 106 move linearly forward on the rod 106 and the carbon fiber tows 108 continuously wind the carbon fiber threads 110 around the CMSs 106, the carbon fiber structure may be manufactured to be of a desired length.

The rod 104 may be of any length. In a non-limiting example, the system 104 may manufacture thin walled two-meter-long lumpy tube (i.e., carbon fiber structure) with a small raised flat area (e.g., every fifty centimeters) that may be used to attach another carbon fiber structural piece.

After the outer mold segments compress the wound carbon fiber threads 112, the CMSs 106 may be further configured to collapse to release the CMSs 106 from the rod 104. Further, collapsing of the CMSs 106 enables the carbon fiber structure to be cut. The CMSs 106 may be configured to split in such a way that the CMSs 106 may be removed from the rod 104 along which the CMSs 106 move linearly. In an embodiment of the present disclosure, the CMSs 106 may include an internal motor to control their own movement along the rod 104 that allows the CMSs 106 to advance out of sync with the other CMSs 106 for some applications.

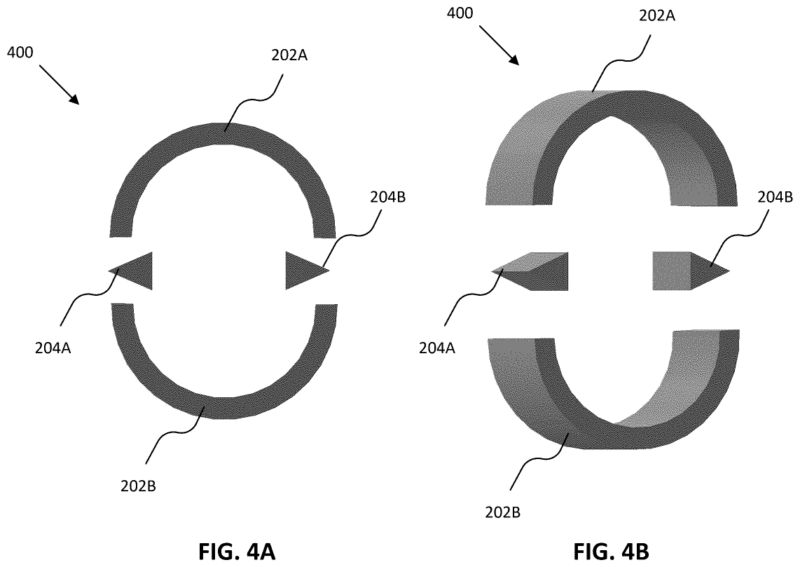

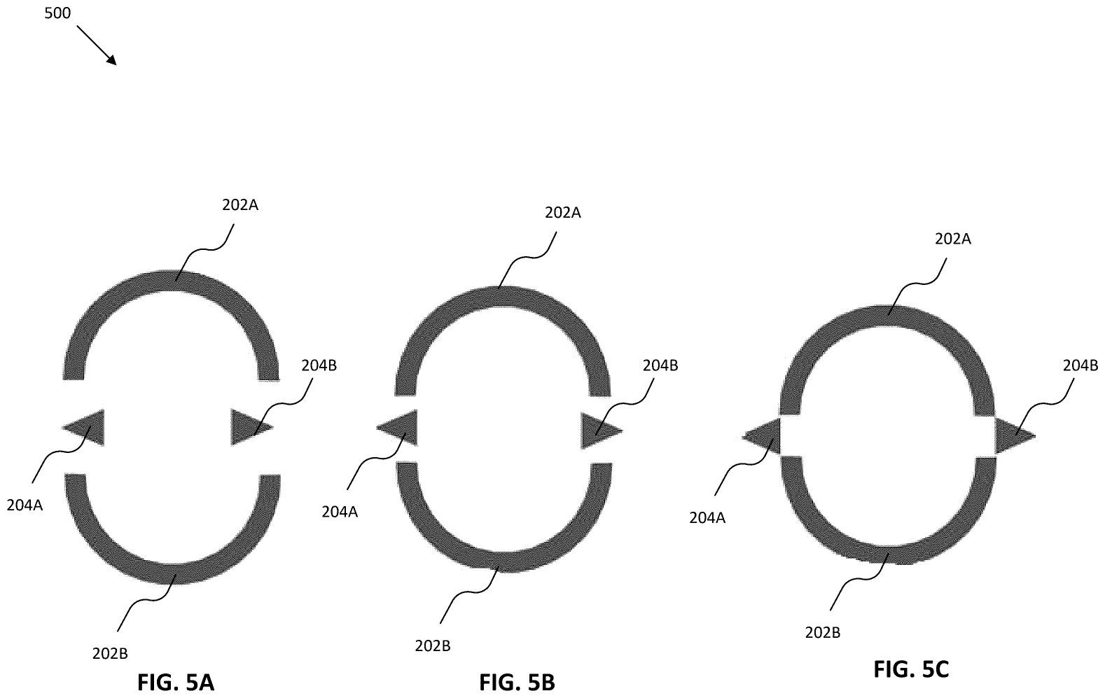

In some embodiments, the system 100 may include a cutting tool (not shown) configured to cut the manufactured carbon fiber structure to release the manufactured carbon fiber structure. In one non-limiting example, the cutting tool is a knife or a laser. After cutting the manufactured carbon fiber structure, the CMSs 106 may be released and reused again to manufacture another carbon fiber structure. A detailed analysis of the system 100 for manufacturing of continuous carbon fiber structure is described below with respect to FIG. 3, FIG. 4, and FIG. 5.

FIGS. 3A-3D, collectively, represent a simplified diagram illustrating a compression technique 300 for manufacturing of continuous carbon fiber structure in which aspects of technology may be employed. The compression technique 300 includes utilization of the wound carbon fiber threads 112, a die spring 302, a guide pin 304, the first CMS 106A, and outer mold segments 306A and 306B. The wound carbon fiber threads 212 are formed into a multilayer prepreg wrap. The first CMS 106A includes a first male portion 106A-1 and a second male portion 106A-2. The multilayer prepreg wrap is formed by spinning the carbon fiber tows 108 around the CMS 106.

Referring now to FIG. 3A, the die spring 302 and the guide pin 304 are used to guide and align die sets, i.e., the first male portion 106A-1 and the second male portion 106A-2, during repeated pressing operations and to facilitate easy die opening after the pressing operations. In most die forming apparatus, means are provided for vertically affixing the die spring 302 to the die sets, generally in die spring pockets. The die spring 302 is positioned in a cylindrical opening drilled in a die, upper or lower portions of CMS 106, known as a spring pocket. The die spring 302 applies a bias to a member called one of: a pad and a stripper. When one of: the pad and the stripper is removed from an upper die member, i.e., the first male portion 106A-1, the die spring 304 will drop out of the spring pocket under the influence of gravity unless retained in the pockets by a retainer.

Referring now to FIG. 3B, a first female portion 306A of the outer mold segment 306 may be configured to compress the wound carbon fiber threads 112 by applying heat and pressure. Referring now to FIG. 3C, a second female portion 306B of the outer mold segment 306 may be configured to compress the wound carbon fiber threads 112 by applying heat and pressure that provide final form of the continuous carbon fiber structure with the edges. Referring now to FIG. 3D, the first female portion 306A and the second female portion 306B of the outer mold segment 306 compress the wound carbon fiber threads 112 further such that the first male portion 106A-1 and the second male portion 106A-2 of the first CMS 106A are compressed and the edges of the manufactured carbon fiber structure are flattened between the portions of the outer mold segment 306. Further, an edge trimming operation is performed on the manufactured carbon fiber structure. Edge trimming operation is the process to cut the edges of continuous carbon fiber structure which are excessive and extends outward to the outer mold segment 306. The edge trimming operation finalizes the manufacturing of the continuous carbon fiber structure.

FIG. 4A and 4B represent simplified diagrams illustrating various views of an exemplary CMS 400 in which aspects of the technology may be employed. The CMS 106 may be configured to manufacture odd-shaped carbon fiber structures, such as a double omega shaped structure. The CMS 400 includes first and second curved portions 402A and 402B and first and second triangular portions 404A and 404B.

FIG. 5A-5C, collectively, represent a simplified diagram illustrating a process 500 of manufacturing the double omega shaped structure using the CMS 400 in which aspects of the technology may be employed. In one embodiment of the present disclosure, the process 500 is performed without the motor (such as the first motor 102) and the guide pin (such as the guide pin 306) for collapsing and extending of the CMS 400.

The manufacturing process 500 using the CMS 400 that starts with the CMS 400 being a straight sided oval shape over which the carbon fiber threads 110 are wound as shown in FIG. 5A which gradually collapses to a circle as shown in the FIGS. 5B and 5C. The CMS 400 moves linearly and may internally shrink vertically and extend horizontally to create a new shape as shown in FIGS. 5A-5C. Further, the CMS 400 may collapse to the circle and the first and second triangular portions 404A and 404B may move to the exterior to take up the extra slack of the wound carbon fiber threads as shown in FIG. 4E.

Further, an outer mold (not shown) may compress across all the sides of wound carbon fiber threads to provide the final shape of the continuous carbon fiber structure. The outer mold may be configured to apply heat and pressure during compression that hardens the material, that is the wound carbon fiber threads. Further, the outer mold may be released with the two half's spreading from a cured carbon fiber structure.

As the CMS 400 advances linearly once enough length of tubing has been created the carbon fiber structure may be cut using an external knife or laser process. After cutting the carbon fiber structure, the CMS 400 may then advance with the cut carbon fiber structure creating a gap between the CMS 400 and the cured fiber, i.e., the manufactured carbon fiber structure, and the other side of the fiber. A rod support (not shown) may clamp onto the rod 104 in the created gap. The segments of the CMS 400 may collapse one by one and advance past the endpoint of a tubular structure of the carbon fiber structure which is manufactured. Further, after collapsing the portions of the CMS 400 are split to be removed from the rod 104. An end-bearing may move and the manufactured carbon fiber structure in the form of fiber tube may be slid off the rod 104. The end bearing may then reattach to the rod 104 and the rod support may recede allowing the process to continue. In another embodiment, the bearings and movements may be continuous to improve throughput.

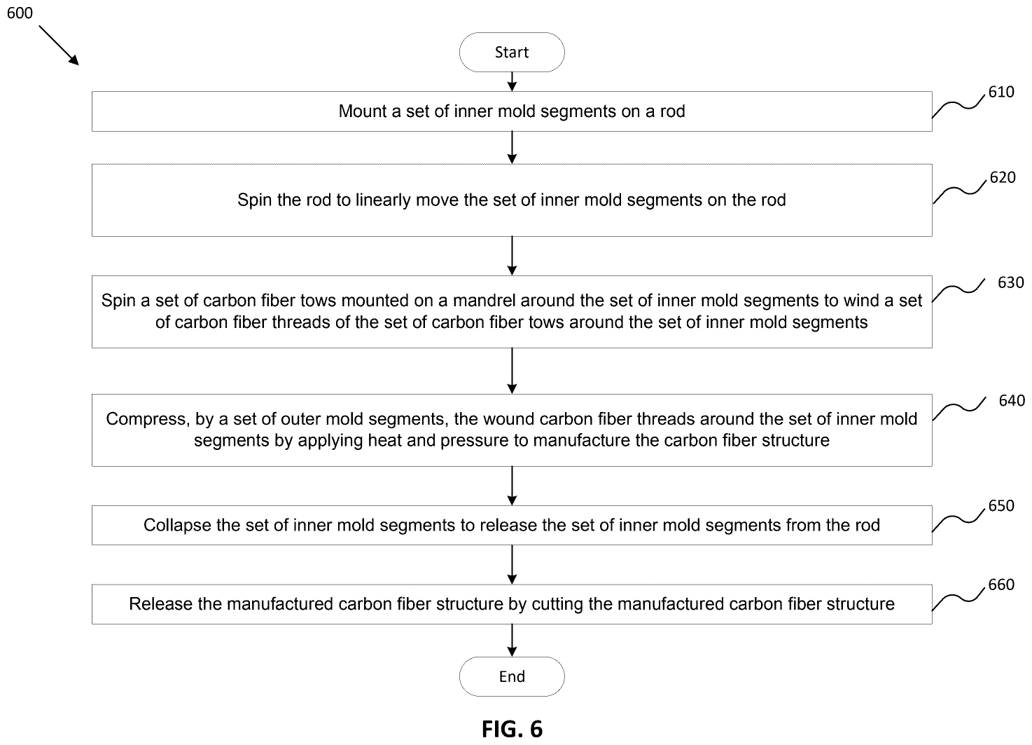

FIG. 6 represents a flowchart illustrating a method 600 for manufacturing the carbon fiber structure according to aspects of the disclosed technology. In accordance with the method 600, at 610, the CMS 106 may be mounted on the rod 104. The rod 104 may correspond to one of: a continuous threaded rod and a cogged center rod. At 620, the first motor 102 may spin the rod 104 to linearly move the CMS 106 on the rod 104. While the CMS 106 are moving linearly, at 630, the second motor 204 may spin the carbon fiber tows 108 mounted on the mandrel 202 around the CMS 106 to wind the carbon fiber threads 110 of the carbon fiber tows 108 around the CMS 106.

Further, at 640, the outer mold segments 306 may compress the wound carbon fiber threads 112 around the CMS 106 by applying heat and pressure to manufacture the carbon fiber structure. In an exemplary embodiment of the present disclosure, each CMS 106 has a different shape such that the carbon fiber structure manufactured may be of different shapes and sizes as per the requirements of specific applications.

Further, in accordance with the method 600 after the compressing of the wound carbon fiber threads 112, at 650, the CMS 106 may collapse to release the CMS 106 from the rod 104. At 660, the knife or the laser may cut the manufactured carbon fiber structure to release the manufactured carbon fiber structure.

The method 600 for continuous manufacturing of a thin walled carbon fiber tubular structure may be able to create a variety of shapes of carbon fiber structures, including repeating variation in shapes (bumps in a tube for instance) while maintaining a continuous web of carbon fiber in multiple orientations and angles to meet the stress requirements of a specific application. The continuous carbon fiber structure thus manufactured may be as thin and delicate as may be desired because at no point is there a pulling stress. The shapes of the resultant tubes of the carbon fiber structure and the addition of stress doublers of carbon fiber structure may allow for high-speed manufacturing of large structures with various designs. The manufacturing process may be continuous and fully automated allowing for lower costs at high volume. The carbon fiber structure may be of many shapes, creating a single stronger and lighter structure instead of multiple structures glued or attached together.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an example embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an example embodiment,” “an exemplary embodiment,” or “other embodiments,” or the like, are not necessarily all referring to the same embodiments. References in the specification to “an embodiment,” “one embodiment,” “some embodiments,” “one particular embodiment,” “an example embodiment,” “an exemplary embodiment,” or “other embodiments,” or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. As used herein in the specification and claims, including as used in the examples and unless otherwise expressly specified, numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

The description and illustration of various embodiments of the disclosure are examples and the disclosure is not limited to the exact details shown or described. While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed:

1. A method for manufacturing a carbon fiber structure, the method comprising:
mounting a set of inner mold segments on a rod;
spinning the rod to linearly move the set of inner mold segments on the rod;
spinning, while the set of inner mold segments are moving linearly, a set of carbon fiber tows mounted on a mandrel around the set of inner mold segments to wind a set of carbon fiber threads of the set of carbon fiber tows around the set of inner mold segments to produce wound carbon fiber threads; and
compressing, by a set of outer mold segments, the wound carbon fiber threads around the set of inner mold segments by applying heat and pressure to manufacture the carbon fiber structure.

2. The method of claim 1, wherein the rod corresponds to one of: a continuous threaded rod and a cogged center rod.

3. The method of claim 1, wherein each of the set of inner mold segments is a collapsible mold segment.

4. The method of claim 1, wherein the set of inner mold segments comprises a first inner mold segment and a second inner mold segment, and wherein the second inner mold segment is mounted on the rod after the first inner mold segment moves linearly on the rod, thereby manufacturing the carbon fiber structure of a desired length.

5. The method of claim 4, wherein the first inner mold segment comprises an upper segment portion that is mounted on the rod from a top and a lower segment portion that is mounted on the rod from a bottom such that the upper segment portion and the lower segment portion of the first inner mold segment move linearly when the rod spins.

6. The method of claim 4, wherein the first inner mold segment has a different shape than the second inner mold segment.

7. The method of claim 1, further comprising:
collapsing, after the compressing of the wound carbon fiber threads, the set of inner mold segments to release the set of inner mold segments from the rod.

8. The method of claim 7, further comprising:
releasing the carbon fiber structure by cutting the carbon fiber structure.

9. The method of claim 8, wherein the carbon fiber structure is cut by a knife or a laser technique.

10. A system for manufacturing a carbon fiber structure, the system comprising:
first and second motors;
a mandrel, wherein the second motor is configured to spin the mandrel;
a rod coupled to the first motor, wherein the first motor is configured to spin the rod;
a set of inner mold segments mounted on the rod, wherein the set of inner mold segments move linearly on the rod when the first motor spins the rod;
a set of carbon fiber tows mounted on the mandrel around the set of inner mold segments and comprising a set of carbon fiber threads, wherein, while the set of inner mold segments are moving linearly, the set of carbon fiber threads of the set of carbon fiber tows are wound around the set of inner mold segments when the second motor spins the mandrel to produce wound carbon fiber threads; and
a set of outer mold segments configured to compress the wound carbon fiber threads around the set of inner mold segments by applying heat and pressure to manufacture the carbon fiber structure.

11. The system of claim 10, wherein the rod corresponds to one of: a continuous threaded rod and a cogged center rod.

12. The system of claim 10, wherein each of the set of inner mold segments is a collapsible mold segment.

13. The system of claim 10, wherein the set of inner mold segments comprises a first inner mold segment and a second inner mold segment, and wherein the second inner mold segment is mounted on the rod after the first inner mold segment moves linearly on the rod, thereby allowing the system to continuously manufacture the carbon fiber structure of a desired length.

14. The system of claim 13, wherein the first inner mold segment comprises an upper segment portion that is mounted on the rod from top and a lower segment portion that is mounted on the rod from bottom such that the upper segment portion and the lower segment portion of the first inner mold segment move linearly when the rod spins.

15. The system of claim 13, wherein the first inner mold segment has a different shape than the second inner mold segment.

16. The system of claim 10, wherein after the set of outer mold segments compress the wound carbon fiber threads, the set of inner mold segments are further configured to collapse to release the set of inner mold segments from the rod.

17. The system of claim 16, further comprising a cutting tool configured to cut the carbon fiber structure to release the carbon fiber structure.

18. The system of claim 17, wherein the cutting tool is a knife or a laser.
